(19) United States
(12) Patent Application Publication
(10) Pub. No.: US 2005/0075905 A1
(43) Pub. Date: Apr. 7, 2005

(54) Customizable automatic generation and ordering of a medical report summary

(76) Inventors: Richard M. Bennett, Half Moon Bay, CA (US); Mark Booney, Pontiac, MI (US); Mark A. Brooks, Gregory, MI (US); Bryan Dotzour, Madison, WI (US); David Ei, Whitmore Lake, MI (US); James Ellison, Brighton, MI (US); Peter J. Magsig, Ann Arbor, MI (US); Indu Khosla, Ann Arbor, MI (US)

Correspondence Address: Alexander J. Burke;Intellectual Property Department, 5th Floor, 170 Wood Avenue South, Iselin, NJ, 08830, US

(21) Appl. No.: 10/922,542

(22) Filed: Aug. 20, 2004

Related U.S. Application Data
(60) Provisional application No. 60/497,161, filed on Aug. 22, 2003.

(51) Int. Cl. G06F 17/60

(52) U.S. Cl. 705/2

(57) ABSTRACT

A method of automatically generating a medical report summary includes the following steps. A medical report which includes one or more parameters is generated. A weight is calculated for the parameters in the medical report. The parameters are ordered based upon the calculated weight. A medical report summary is created that lists the parameters that have been ordered based upon the calculated weight.

The present application claims priority that is derived from provisional patent application Ser. No. 60/497,161, which was filed on Aug. 22, 2003.

### FIELD OF THE INVENTION

The present invention relates generally to the field of data processing and report generation, and more specifically to the field of automatically generated clinical report summaries created when, for example, a physician performs patient care duties at a medical care facility.

### BACKGROUND

One typical consequence of a patient undergoing either an examination or receiving treatment, e.g. in a hospital environment, is the creation of a report of findings authored by the diagnosing physician. The findings are textual descriptions of the diagnosis, examination results and/or treatment protocol. A summary list of findings, often in the form of an outline or a bulleted list, is typically included as a part of this report. The summary restates findings that appear in the body of the report, thereby permitting a subsequent reader of the report to determine the most relevant information by reading the summary listing. Commonly, physicians want items in the summary findings section ordered or ranked according to their severity. Some items may rank so low that the physician does not want them included in the report summary. In any particular case the physician may wish to comment on some of the summary findings regardless of their severity, and/or include other summary findings if those findings are sufficiently serious.

In addition, physicians often perform examinations and order tests to confirm or disprove a preliminary diagnosis. A physician may want findings in a summary report selected and ordered to emphasize the relationship between the summary report and the preliminary diagnosis. For example, if the examination and tests do not find any evidence to support the preliminary diagnosis, then the summary report should be ordered to highlight that fact.

Modern healthcare facilities utilize computer based data storage and processing equipment. This equipment includes medical reporting software packages which facilitate the creation of such reports by the physician or other user. One feature of such report generating programs is the capability for the physician to generate the list of summary findings.

Some existing report generation programs automatically generate the summary findings from a combination of the measurement values, text or other data entered in the body or the report. Typically, the automatic generation of the report summary involves relying on a predetermination that certain items in the main body of the report are assigned a given relevance or importance. Such items are automatically copied from the body of the report into the summary findings section.

However, even when utilizing an automatically generated summary list program, the diagnosing physician reviews and often add, remove, and/or edit the findings automatically inserted into the list. Further, for any given patient undergoing examination or treatment, the diagnosing physician may wish to include in the summary report some items appearing in the body of the report but not automatically selected for inclusion in the summary. The physician may also wish to delete items automatically appearing in the summary findings, and he or she may wish to reorder the entries in summary findings report.

A need therefore exists for a report generation program that improves the quality of an automatically generated clinical report by utilizing appropriate problem solving techniques to determine which findings are to be included in the medical report summary. A further need exists to permit the sorting and ranking of the summary findings by means of a user definable algorithm.

### SUMMARY OF THE INVENTION

In accordance with principles of the present invention, a method of automatically generating a medical report summary includes the following steps. A medical report is generated to include one or more parameters. A weight is calculated for the parameters in the medical report. The parameters are ordered based upon the calculated weight. A medical report summary is created that lists the parameters that have been ordered based upon the calculated weight.

### BRIEF DESCRIPTION OF THE DRAWINGS

FIG. 1 is a depiction of a graphical user interface illustrating the principles of the present invention;

FIG. 2 is a depiction of the graphical user interface illustrated in FIG. 1 when being utilized for the creation of observations which are the source of summary findings;

FIG. 3 is a flow chart illustrating the operational steps performed in order to create a summary report according to the principles of the present invention; and

FIG. 4 is a block diagram of a computer network which may be used to implement the present invention.

### DETAILED DESCRIPTION OF THE INVENTION

An executable application, as used herein, comprises code (i.e. machine readable instructions) for implementing predetermined functions, for example those of: an operating system, a healthcare information system, or other system for processing data, either stored in the computer system or entered by a user, in response to user command or input. An executable procedure is a segment of code, a subroutine, or other distinct section or portion of code of an executable application for performing one or more particular processes, such as receiving input parameters or user command data, performing operations on the received input parameters and/or in response to the user command data, and/or providing resulting output parameters.

A processor, as used herein, is a device for performing tasks as specified by an executable application or other set of machine-readable instructions. A processor operates by executing the instructions contained in the executable application. The processor may be controlled in this manner to receive information from an external information device, to manipulate, analyze, modify, convert the received information, and/or to transmit information to an external information device. As used herein, a processor may comprise hardware, firmware, and/or software. For example, a processor may use or comprise the capabilities of a controller or microprocessor. A display processor or generator is a known element of a processor comprising electronic circuitry or software, or a combination of both, for generating signals representing display images or portions thereof. These image representative signals are supplied to a display device which displays the image represented by the signals. A user interface comprises one or more display images enabling user interaction with a processor or other device.

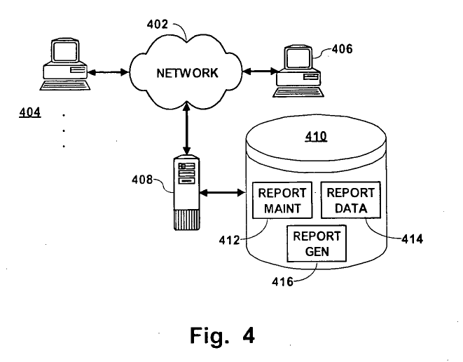

FIG. 4 is a block diagram of a computer network. In FIG. 4, a network 402 interconnects a plurality 404, 406 of workstations. The workstations include a processor, input devices such as a keyboard and/or pointing device, and a display device for displaying images under the control of the display generator in the processor. A server computer 408, also including a processor, is also coupled to the network 402. The server computer 408 is coupled to a mass storage device 410, such as a disk drive, on which may be stored executable applications and data generated and/or processed by the executable applications.

In operation, the plurality 404, 406 of workstations may interact with resources of their own, of other workstations 404, 406, and/or of the server computer 408 via communications over the network 402. More specifically, the plurality 404, 406 of workstations, may interact with the server computer 408. The server computer 408, in turn, retrieves executable applications and/or data from the mass storage device 410 and forwards the executable applications and/or data to the requesting workstation 404, 406. The workstation 404, 406 executes the executable application to process the data under the control of the user of the workstation. The executable application may generate data which may be sent back to the server computer 408 to be stored in the mass storage device 410 via the network 402.

For example, the mass storage device 410 may have stored in it a report maintenance executable application 412. The report maintenance executable application 412, when transferred to and executed on one of the workstations, e.g. 406, under control of a user, may generate report data specifying how a medical report is to be processed to automatically generate a summary report. This report data may be sent back to the server computer 408 from the workstation 406. The server computer 408 stores the report data 414 on the mass storage device 410. The mass storage device may also have stored in it a report generating executable application 416. The report generating executable application 416, and the report data 414, when transferred to and executed on one of the workstations, e.g. 404, under control of a diagnosing physician, may be used to generate and/or process a medical report to automatically generate a summary report to be associated with the medical report.

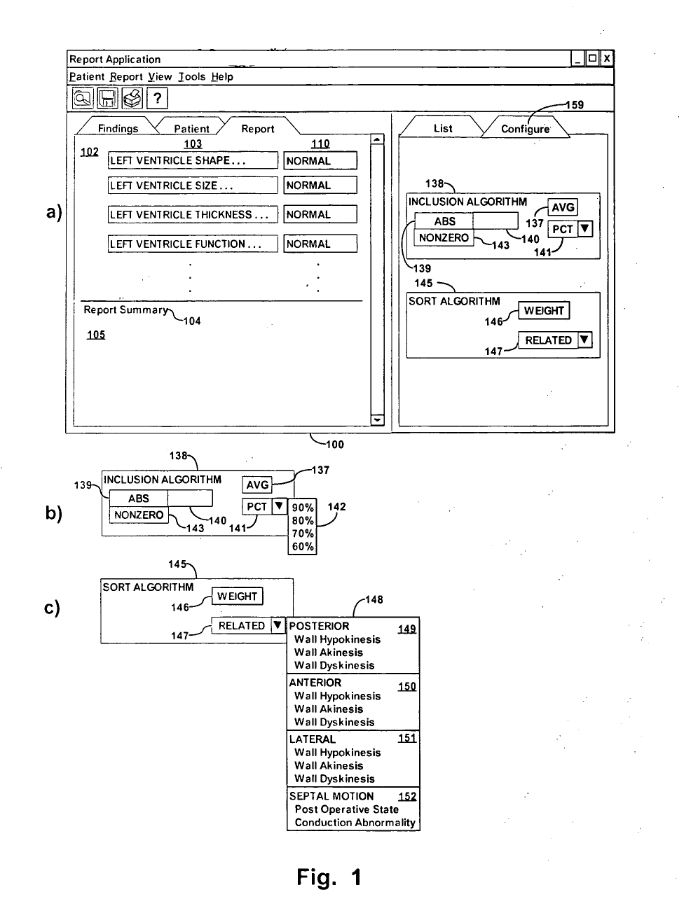

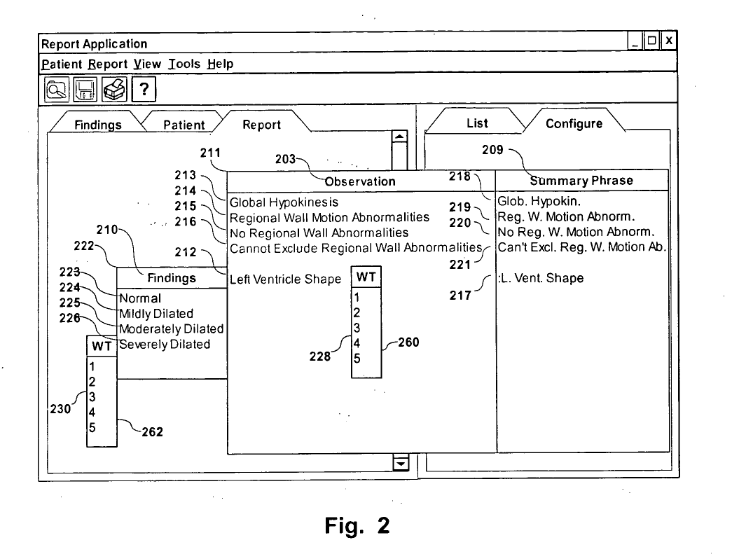

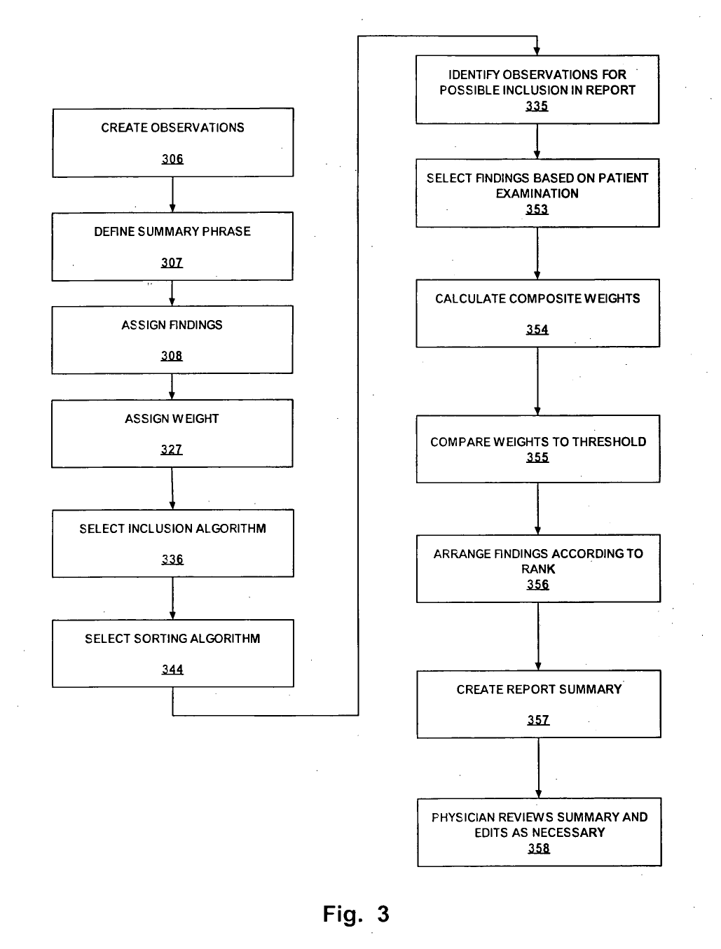

In FIG. 1, a graphical user interface 100 is depicted which is displayed on a display device under the control of the report maintenance executable application 412. The graphical user interface 100 permits a user to configure and access report summary creation features of the present system. FIG. 1a illustrates the overall graphical user interface, while FIG. 1b and FIG. 1c illustrate respective portions of the graphical user interface 100 in more detail. FIG. 2 illustrates a configuration of the graphical user interface 100 illustrated in FIG. 1, and FIG. 3 illustrates the steps performed by the report maintenance executable application 412 and the report generation executable application 416. The left-hand side of FIG. 3 illustrates steps performed by an administrating physician or other user in configuring the automatic generation of a summary medical report using the report maintenance executable application 412 (FIG. 4). The right-hand side of FIG. 3 illustrates steps performed by a diagnosing physician in automatically generating a summary medical report using the report generating executable application 416. The steps illustrated in FIG. 3 may be performed under control of software, firmware, hardware or any combination of them.

A medical report includes, among other things, two parameters: observations and findings. As used herein, the term ‘observation’ means a physiological feature of a patient determined by one or more examinations of and/or tests performed on the patient. For example, the shape of the left ventricle of the patient is an observation. The term ‘finding’ means the result of the examinations and/or tests. Each observation may result in one of a plurality of possible findings. Continuing the example, the findings of the observation of the left ventricle shape may be: “normal”, “mildly dilated”, “moderately dilated” or “severely dilated”. The findings may also be a numerical. For example, the observation of the patient's SpO₂ level results in a finding expressed as a number, in this case a percentage.

Typically, an administrating physician or department chair initially configures the automatic report summary creation features, described in more detail below, by executing the report maintenance executable application 412 (FIG. 4) using the graphical user interface 100 displayed on one of the plurality of workstations, e.g. 406. Report data 414 is generated including data representing menus, observation lists, weighted values and associated algorithms. The report data 414 is stored in the mass storage device 410. The remaining users, typically the diagnosing physicians, automatically compose report summaries by executing the report generating executable application 416 on one of the plurality of workstations, e.g. 404. The report generating executable application 416, in turn, accesses the report data 414 and utilizes the data representing the previously created menus, observation lists, weighted values and associated algorithms.

In FIG. 1, the user interface 100 includes on the left-hand side a report composition region 102 in which the user, typically a diagnosing physician, may enter observations 103 made and associated findings 110 based on a study setting out details of the examination, testing, or treatment of a patient. At least some of the observations 103, and their related findings 110, may be included in a report summary. The report summary region 105, labeled “Report Summary” 104, is displayed below the report composition region 102 of the graphical user interface 100.

The administrating physician or user is able to configure the manner in which the report summary 105 is automatically created by selecting the “Configure” tab 159 on the right-hand side of the graphical user interface 100. Referring to FIG. 2, in response the report maintenance executable application conditions the display device to display a submenu 211 for the user. The report maintenance executable application enables the administrating physician to perform the steps illustrated on the left-hand portion of FIG. 3. The initial step 306 is the creation of a set of possible observations 203 using the submenu 211, for example observations 212, 213, 214, 215 and 216, which pertain to typical scenarios occurring during the examination and/or treatment of a patient. The administrating physician may also define at step 307 summary phrases 209, for example 217, 218, 219, 220 and 221, which are respectively associated with the observations 212, 213, 214, 215 and 216.

The administrating physician associates, at step 308, a set of one or more findings 210 (FIG. 2) with an observation. For example, as described above, cardiologists are often interested in the shape of the heart's left ventricle. The administrating physician might, therefore, create an observation 212 called the “Left Ventricle Shape”. The summary phrase assigned to the observation “Left Ventricle Shape” 212 may be, for example “L. Vent. Shape” 217. The possible findings 210 associated with the observation 212 and its summary phrase 217 are specified in the submenu 222. For example, possible findings for the observation “Left Ventricle Shape” 212 may include “Normal” (223), “Mildly Dilated” (224), “Moderately Dilated” (225), and “Severely Dilated” (226). Referring to submenu 260, the user is able to assign respective values 228 to the set of possible observations 212 and using the submenu 262 is able to assign respective value 230 to the set of possible finding 226 associated with an observation 212. Values may be assigned to the other observations 203 and/or findings 210 in a similar manner.

Alternatively, summary phrases may be assigned to the possible findings, and may include further information which may be deemed important to a person reviewing the medical report and the summary report. For example, instead of, or in addition to, a summary phrase “L. Vent Shape” 217 assigned to the observation 212, a summary phrase may be assigned to each finding associated with that observation 212. For example, a summary phrase assigned to the finding “Normal” 223 may be “The left ventricle is normal”; the summary phrase assigned to the finding “Mildly Dilated” 224 may be “The left ventricle is mildly dilated”; the summary phrase assigned to the finding “Moderately Dilated” 225 may be “The left ventricle is moderately dilated and should be rechecked in one year”; and the summary phrase assigned to the finding “Severely Dilated 226 may be “The left ventricle is severely dilated and surgery is recommended.” These phrases may be substituted for the raw findings 223, 224, 225 and 226 in the medical summary report.

During creation of a medical report, described in more detail below, selecting an observation and choosing one of its findings results in selection of the associated summary observation phrase and calculation of its weight from the values assigned to the observation and finding. The weight may be calculated algorithmically by combining the value assigned to the observation and the value assigned to the associated finding in order to create a composite weight. For example, the weight associated with an observation may be multiplied by the weight associated with a finding to calculate the composite weight associated with that finding. The resulting weight may be scaled to be within a predetermined range. Alternatively, some other function of the observation value and finding value may be used, such as a weighted average, a summation or weighting an observation value differently than a finding value. It is also possible to use just the observation value or just the finding value in calculating the weight. It is further possible to calculate the weight for a finding based on values assigned to more than one selected observation and finding. The administrating physician may specify such algorithms.

The calculated composite weight is utilized by subsequent inclusion and sorting algorithms, described below. For example, a convention may be adopted of assigning lower values or weights to less important (i.e. less severe) observations/findings and higher values or weights to more important (i.e. more severe) observations/findings. Observations and findings with higher values or weights may be listed before those of lower values or weights in the summary report, thus ensuring that more important observations and findings are listed first, followed by less important observations and findings. One skilled in the art will understand, however, that this is an arbitrary convention, and any other such convention which leads to appropriate selection and sorting may be used.

Values 228, related to the severity, are assigned to the observations 203 and values 230, related to the severity, are assigned to the findings 210 at step 327. Observations of more important physiological parameters receive a higher value than observations of less important physiological parameters. Similarly, with respect to the value of a finding, more serious findings receive a higher value than less serious findings. That is, the “Normal” finding 23 might be assigned a value of 0 (zero), the “Mildly Dilated” finding 24 may be assigned a value of 2 (two), the “Moderately Dilated” finding 25 is assigned the value of 6 (six), while the “Severely Dilated” finding 26 might be assigned a value of 10 (ten).

After the observations 203, summary phrases 209, findings 210 and values 228, 230 have been specified, as described above, the administrating physician may also define or select an inclusion algorithm at step 336 (FIG. 3) for determining whether a finding 110 (FIG. 1) is to be included in the report summary 105, and a sorting algorithm for determining how the included findings 110 are sorted or ranked within the report summary 105.

An inclusion algorithm selection box 138, illustrated in more detail in FIG. 1(b), permits the specification of one of a plurality of inclusion algorithms. The inclusion algorithm may be as simple as utilizing a threshold value that determines whether the finding is included in the report summary 105. An absolute threshold value algorithm may be selected by activating a button 139, and specifying a threshold value in text box 140 in which the threshold value (for example, a number between 0 and 10) may be entered. For example, if a value of five is entered in box 140, findings 110 (FIG. 1) having a weight or composite weight equal to or greater than five are included in the report summary 105 and the others are not.

An averaging inclusion algorithm, selected by activating a button 137, is another menu selection appearing on user interface 100. When the averaging algorithm is selected, the weights of the findings are averaged and findings having weights equal to or greater than the average weight are included in the report summary 105.

Activating a button 141 selects a percentile inclusion algorithm in which an upper portion of findings may be chosen in accordance a selection made from the accompanying percentile menu 142. For example, a selection of 90% in the percentile menu 142 results in setting a threshold value at the 90^{th} percentile, that is at a point where 90% of the findings have weights less than the threshold value and 10% of the findings have weights greater than the threshold value. The 10% of the findings greater than the threshold value are selected to be included in the report summary 105. Other selections from the percentile menu 142 result in setting the threshold value at the 80^{th}, 70^{th}, or 60^{th} percentile. Activating a button 143 implements an inclusion algorithm which selects findings having a nonzero weight. Regardless of the inclusion algorithm chosen, whenever the calculated weight of the finding 210 (FIG. 2) equals or exceeds the threshold calculated by the inclusion algorithm, that finding and the associated summary observation phrase 209 is automatically inserted into the report summary 105.

At step 344 the administrating physician selects a sorting algorithm. The sorting algorithm orders the included findings 110 (FIG. 1) and their associated observations 103 for presentation in the report summary 105 (FIG. 1). The sorting algorithm selection box 145, illustrated in more detail in FIG. 1(c), appears on user interface 100. The sorting algorithm may be as simple as ordering the findings 110 according to their weight, from higher weighted findings to lower weighted findings, which is chosen by activating a button 146. If the user desires to keep related findings together, a button 147 is activated, which reveals submenu 148. The submenu 148 lists various groupings of observations 203 (FIG. 2) as defined by the administrating physician. When observations 103 and findings 110 (FIG. 1), as specified by the diagnosing physician, are included in the summary report 105, they are presented together according to the groupings in submenu 148 in order of descending weight, provided that the lowest weight finding presented is at least equal to the value chosen by the inclusion algorithm. For example, cardiology groupings may include findings related to posterior wall observations 149, findings related to anterior wall observations 150, findings related to lateral wall observations 151 and findings related to septal motion observations 152.

The customization of the automatic generation of a report summary 105, as described by steps 306, 307, 308, 327, 336 and 344, is typically performed by an administrating physician when the report maintenance executable application 412 (FIG. 4), producing the user interfaces 100 (FIG. 1) and 211 (FIG. 2), is initially executed on a workstation, e.g. 406 (FIG. 4), before diagnosing physicians are able to execute the report generation executable application 416. However, the report maintenance executable application 412 may be re-executed on a workstation, e.g. 406, and the user interfaces 100 (FIG. 1) and 211 (FIG. 2) permit editing of existing observations 203 and findings 210, and the addition of new observations 203 and findings 210, whenever necessary.

Referring again to FIG. 4, after the initial summary report automatic generation customization is performed, the diagnosing physician retrieves and accesses the report generation executable application 416 and the associated report data 414 from the mass storage device 410 via the server computer 408 and network 402. The diagnosing physician reviews a medical study outlining the results of a medical examination of, and/or tests performed on, the patient. Based on this study, the diagnosing physician uses the report generation executable application 416 to generate a medical report. The report generation executable application 416 automatically generates the report summary while the diagnosing physician is generating the medical report.

Referring to FIG. 3, the diagnosing physician may, at step 335, access user interface 100 (FIG. 1), to specify the observations 103, selected from among those created by the administrating physician using the submenu 211 (FIG. 2), made via patient examination, testing, and/or treatment. The diagnosing physician, at step 353, associates respective findings 110, selected from among those created by the administrating physician using the submenu 222 (FIG. 2), with the specified observations 103, based on the results of the examination, testing or treatment of the patient. In this manner, a medical report is generated in area 102 by the diagnosing physician. This medical report is processed in accordance with the configuration of the system, as described above, to concurrently and automatically generate a summary medical report in area 105 as the medical report is being created by the diagnosing physician in area 102. Alternatively, a previously created medical report may be retrieved and displayed in area 102, and that medical report reviewed and processed in a similar manner to automatically generate a summary medical report in area 105.

In either case, respective weights, optionally comprising composite weights, are calculated for the findings 110 (FIG. 1) specified by the diagnosing physician, in step 354. As described above, the weights are calculated according to the algorithm specified by the administrating physician. The findings 110 are processed by the preselected inclusion algorithm, at step 355, to determine which findings are included in the report summary 105 (FIG. 1). More specifically, the calculated weights are compared to the threshold determined by the preselected inclusion algorithm. If they exceed the threshold, they are included in the report summary 105. The preselected sorting algorithm determines, at step 356, the order in which the findings appear in the report summary 105. The report summary is created automatically in area 105 at step 357. After viewing the raw examination data and selecting relevant observations 103 and findings 110, the diagnosing physician may review the automatically generated report summary 105 and make manual modifications to the report summary 105 as necessary at step 358.

While the report summary section 105 of a report may be configured to include summary findings that exceed a specified weight, it may also be configured to include summary findings having a specific weight or a weight below a certain threshold value. Similarly, sorting of the findings may be based on the weights of the observations 103 rather than the weights of the findings 110 alone. Other similar changes to the weighting, selection and sorting algorithms may be made.

1. A method of automatically generating a medical report summary comprising the steps of:
generating a medical report including one or more parameters;
calculating a weight for the one or more parameters in the medical report;
ordering the parameters based upon the assigned weight;
creating a medical report summary that lists the parameters that have been ordered based upon the assigned weight.

2. The method of claim 1, further comprising the steps of:
assigning a first weight to a first parameter;
assigning a second weight to a second parameter associated with the first parameter; and
combining the first and second weights to calculate a composite weight.

3. The method of claim 2, further comprising the steps of:
establishing a parameter inclusion threshold value based upon parameter weight;
excluding parameters from the medical report summary whenever the composite weight associated with the parameter is less than the parameter inclusion threshold value; and
including parameters in the medical report summary whenever the composite weight associated with the parameter is greater than the parameter inclusion threshold.

4. The method of claim 3, further comprising the steps of:
associating a summary phrase with each parameter; and
substituting the summary phrase for the parameter in the medical report summary.

5. The method of claim 4, further comprising the steps of:
entering an observation in a first region of the medical report;
associating at least one parameter with each observation; and
entering the summary phrase associated with each selected parameter in a second region of the medical report.

6. The method of claim 5, further comprising the step of assigning a numerical component as the value of each parameter, the numerical component being within a range between a first value corresponding to a normal medical condition and a second value corresponding to an abnormal medical condition.

7. The method of claim 6, wherein intermediate values of the numerical component vary according to a relative importance assigned to each parameter.

8. The method of claim 6, wherein the parameter inclusion threshold permits inclusion of every abnormal medical condition in the medical report.

9. The method of claim 2, wherein the parameter inclusion threshold is derived from an average of the composite weights of the parameters.

10. The method of claim 2, wherein the parameter inclusion threshold is selected as a percentile of the composite weights of the parameters.

11. A method of automatically including desired findings in a document, comprising the steps of:
creating a set of possible observations;
creating a set of possible findings associated with each observation;
assigning a value to each possible observation;
assigning a value to each possible finding;
calculating a weight for each finding based on the respective values assigned to the finding and associated observation; and
establishing an inclusion threshold; whereby
findings are included in the documents that have a first predetermined relationship between the calculated weight and the inclusion threshold.

12. The method of claim 11, further comprising the step of excluding findings from the document that have a second predetermined relationship between the calculated weight and the inclusion threshold.

13. The method of claim 12, further comprising the steps of:
selecting an observation from among the set of possible observations;
selecting one finding from among the set of possible findings associated with the selected observation;
calculating the weight of the selected finding by combining the respective values assigned to the selected observation and the associated one finding so as to create the weight.

14. The method of claim 13, further comprising the step of deriving the inclusion threshold from an analysis of weights resulting from at least some of the selected observations and findings.

15. The method of claim 14, further comprising the step of presenting the findings included in the document in an order derived from the assigned value of the finding.

16. The method of claim 14, further comprising the step of presenting findings included in the document in an order derived from the calculated weight associated with each finding.

17. An executable application directing a computer to perform a method of generating a report summary, the method comprising the steps of:
displaying a set of first parameters each being assigned a value;
identifying a plurality of the first set of parameters as selected first parameters;
displaying a plurality of sets of second parameters, the plurality of sets being respectively associated with the plurality of selected first parameters, each second parameter being assigned a value;
identifying a plurality of second parameters, respectively selected from the plurality of sets of second parameters, as selected second parameters;
calculating respective weights for the plurality of selected second parameters; and
including at least some of the selected first and second parameters in the report in response to the calculated weights for the selected second parameters.

18. The executable application as set forth in claim 17, further comprising the step of presenting at least some of the selected first and second parameters included in the report in an order derived from the weight of each parameter.

19. The executable application as set forth in claim 18, further comprising the steps of:
establishing a threshold value;
comparing the weight assigned to each selected second parameter to the threshold value; and
including at least some selected first and second parameters in the report in response to the relationship between the weight assigned to the selected second parameter and the threshold value.

20. A storage medium, comprising:
a report maintenance executable application for generating report data by:
creating a set of possible observations;
creating a set of possible findings associated with each observation;
calculating a weight for each finding; and
a report generating executable application, responsive to the report data, for generating a medical report summary by:
generating a medical report including a subset of observations selected from the set of possible observations, each observation in the subset being associated with a selected one of the set of possible findings associated with that observation;
ordering the observations and associated findings according to the weight calculated for each finding; and
creating the medical report summary that lists the observations and associated findings that have been ordered based on the assigned weight.

21. A processing system for automatically generating a medical report summary, comprising:
a storage device storing:
a report maintenance executable application;
a report generation executable application; and
report data;
a first processor, coupled to the storage device, for executing the report maintenance executable application to generate and to condition the storage device to store the report data by:
creating a set of possible observations;
creating a set of possible findings associated with each observation;
calculating a weight for each finding; wherein:
the report data comprises the set of possible observations, the set of possible findings and the calculated weights; and
a second processor, coupled to the storage device, for retrieving the report data and executing the report generation executable application to generate the medical report summary by:
generating a medical report including a subset of observations selected from the set of possible observations, each observation in the subset being associated with a selected one of the set of possible findings associated with that observation;
ordering the observations and associated findings according to the weight calculated for each finding; and
creating the medical report summary that lists the observations and associated findings that have been ordered based on the assigned weight.

22. The system of claim 21 wherein”
the first processor further calculates a threshold; and
the second processor includes in the medical report summary observations and associated findings whose weight has a first relationship with the calculated threshold
